(19) United States
(12) Patent Application Publication
(10) Pub. No.: US 2008/0042954 A1
(43) Pub. Date: Feb. 21, 2008

(54) Method of preventing image sticking for liquid crystal display

(75) Inventors: Chien-Pang Lee, Padeh City (TW); Hsien-Ching Chiu, Padeh City (TW)

Correspondence Address: BIRCH STEWART KOLASCH & BIRCH, PO BOX 747, FALLS CHURCH, VA, 22040-0747, US

(73) Assignee: CHUNGHWA PICTURE TUBES, LTD

(21) Appl. No.: 11/586,717

(22) Filed: Oct. 26, 2006

(30) Foreign Application Priority Data
Aug. 18, 2006 (TW) 95130453

(51) Int. Cl. G09G 3/36

(52) U.S. Cl. 345/89

(57) ABSTRACT

A method of preventing an image sticking for a liquid crystal display includes alternately providing a high gray-level picture and a low gray-level picture between any two adjacent pictures, wherein the backlight is turned off. Or, in the turning-off process of the liquid crystal display, the high gray-level picture and low gray-level picture are provided alternately to the display panel. Therefore the ion densities of the pixels on the display panel are adjusted to the same or approximately the same to present a uniform image.

### BACKGROUND OF THE INVENTION

1. Field of the Invention

The present invention relates to a method of solving image sticking for a liquid crystal display (LCD), and more especially, to a method of preventing the image sticking for a liquid crystal display.

2. Background of the Related Art

The liquid crystal display having the advantages of high resolution and good image quality is applied to the flat display panel. However, when a static image is displayed over a long period of time, the image sticking by the static image may take place on the following image, that is, the proceeding static image or outline thereof will present on the following image. It is because when a long-term static image is displayed (or the LCD is operated in the status of the direct current bias for a long time), the ion density of the liquid crystal in each pixel will increase due to the material characteristic of the liquid crystal itself or the matching condition of the liquid crystal with the other related material, therefore the difference of the ion densities among the pixels will change the expected pixel voltage of the following images. An explanatory example is described as follows:

(1) When presenting a general static image:
Vₚᵢₓₑₗ=Vₛ−V_{com}, where Vₚᵢₓₑₗ is the pixel voltage, Vₛ is the source voltage and V_{com} is the common voltage.

(2) After the image sticking generates:
Vₚᵢₓₑₗ=Vₛ−V_{com}−Vᵢₒₙ, where Vᵢₒₙ is the voltage from the ion.

Accordingly, because of the change of the pixel voltage, the expected gray-level of the pixel will not be displayed, and the color brightness will be less than the expected value to cause the color shift, such as blue shift and red shift, etc.

Two methods of preventing or eliminating the image sticking for a liquid crystal display, which exited in the present industries, are explained as follows:
(1) Screen Saver: the LCD switches to display a screen saver of a dynamic image in response to detection on the long-term static image. However, the execution of the screen saver is of no use for an existed image sticking. Besides, the screen saver does not take effect for a localized image, such as a logo which is always shown on the screen.
(2) The dynamic adjustment of the common voltage (Vcom): with a unique parameter, a common voltage is dynamically adjusted for a whole screen to remedy the generation of the image sticking. However, the dynamic adjustment can not apply to each pixel color respectively when the static image is a color picture, such that this method can not completely overcome the image sticking. Moreover, the adjustable parameter also can not correspond to the various static images and this dynamic adjustment method of the common voltage is only a remedy method rather than a method to prevent the generation of the image sticking effectively.

According to the trend of high response speed of the liquid crystal, the response time is shortened to make the generation of the image sticking more easily, and therefore the image sticking is a long-lasting question for the LCD and needs to be overcome.

### SUMMARY OF THE INVENTION

In order to solve the forgoing problems, one object of this invention is to provide a method of preventing the image sticking for a liquid crystal display, it utilizes the rapid switches of the high gray-level pictures and the low gray-level pictures to adjust the ion densities of the pixels to the same or approximately the same and then present a uniform image to remove the image sticking.

One object of this invention is to provide a method of preventing the image sticking for a liquid crystal display, it is suitable for any LCD with different backlight module and can be performed on any time to have the high practicability.

One object of this invention is to provide a method of preventing the image sticking for the liquid crystal display, which has the advantage of removing the residue image.

Accordingly, one embodiment of the present invention provides a method of preventing the image sticking for a liquid crystal display, the method provides at least an image-amendment set containing a high gray-level picture and a low gray-level picture between any two adjacent pictures.

Another embodiment of the present invention provides a method of preventing an image sticking for a liquid crystal display, the method provides alternatively switching at least a high gray-level picture and a low gray-level picture for said display panel during a turning-off process of the liquid crystal display.

### BRIEF DESCRIPTION OF THE DRAWINGS

FIG. 1 is a relative table to illustrate the order of the pictures corresponding to the status of the light source in accordance with an embodiment of the present invention;

FIG. 2 is another relative table to illustrate the order of the pictures corresponding to the status of the light source in accordance with the embodiment of the present invention; and

FIG. 3 is another relative table to illustrate the order of the pictures corresponding to the status of the light source in accordance with the embodiment of the present invention.

### DETAILED DESCRIPTION OF THE INVENTION

The present invention utilizes a method of switching a high gray-level picture and a low gray-level picture to adjust the ion densities of the pixels of the display panel to prevent the image sticking. The characteristics of the present invention are illustrated according to the displaying status and the turning-off status of the LCD respectively, and for clearly expressing the present invention, a simple structure of the LCD is provided at the beginning.

The LCD includes a backlight module to provide a light source and a display panel to display the images, wherein the display panel has a plurality of signal drivers to transform the gray-level signals into the corresponding voltage signals, and then depending on a plurality of signal lines connected with the signal drivers, the voltage signals are transmitted to the display panel. A plurality of gate drivers are utilized to provide the successive scanning signals, which are transmitted to the display panel by a plurality of gate lines connected with the gate drivers. Further, the gate lines are perpendicular to the signal lines so that the gate and signal lines cross to each other to define a pixel region.

### (1) Method Applied During Displaying for the LCD

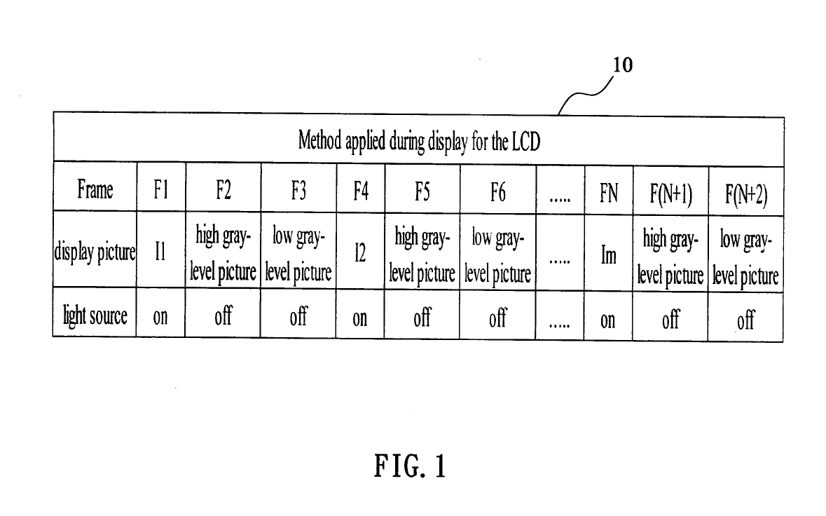

The displayed image is constituted of a series of successive pictures (I1, I2, I3, . . . Im, m is a positive integer). The method of preventing the image sticking for LCD during displaying is to provide an image-amendment set containing a high gray-level picture and a low gray-level picture between any two adjacent pictures, wherein the luminance of the high gray-level picture and the low gray-level picture is different. Please refer to FIG. 1, which is a relative table 10 to illustrate the order of the pictures corresponding to the status of the light source, wherein in the successive frames, F1, F2, F3, F4, F5, F6 . . . . Fn, F(n+1), F(n+2), n is a positive integer, the display panel displays the corresponding pictures. Understandably, the picture I1 is displayed in F1, the high gray-level picture is displayed in F2, the low gray-level picture is displayed in F3, the next picture I2 is displayed in F4, the high gray-level picture is displayed in F5, the low gray-level picture is displayed in F6 . . . , and the final picture Im is displayed in Fn, the high gray-level picture is displayed in F(n+1), and the low gray-level picture is displayed in F(n+2). Next, the high gray-level picture is provided with the signal lines transmitting low voltage signals to the display panel, and the low gray-level picture is provided with the signal lines transmitting high voltage signals to the display panel. By means of the extreme voltage variation between the high gray-level picture and the low gray-level picture, separated ions and electrons are recombined to reduce the ion density and then adjust the ion densities of the pixels to the same to avoid the generation of the image sticking on the following pictures.

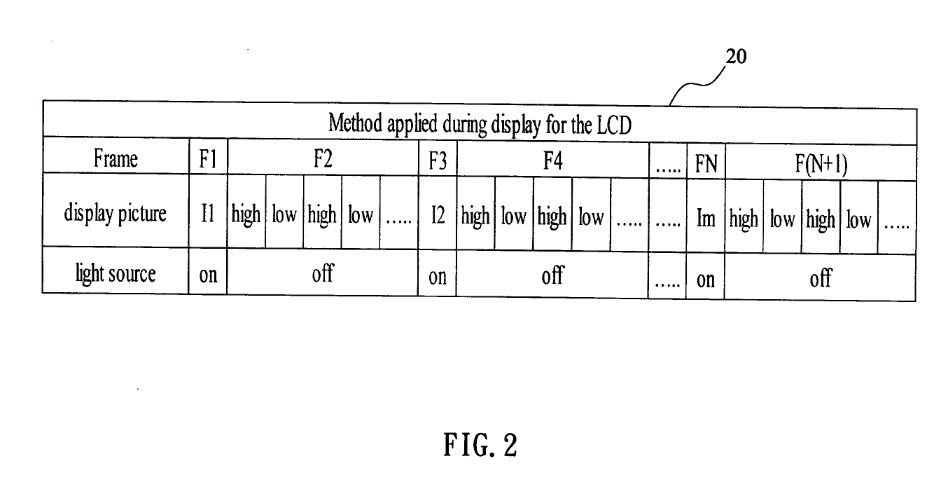

To continue the above description, the high gray-level picture is a white picture and the low gray-level picture is a black picture. The alternative switches between the high gray-level pictures and the low gray-level pictures will cause the image display to flicker and make the viewer feel physiologically and psychologically uncomfortable. To avoid the flickering phenomenon, the light source of the LCD is turned off (off) when displaying the high gray-level picture and the low gray-level picture as illustrated in FIG. 1, and the light source is turned on (on) when displaying the picture.

Wherein, after outputting each picture by a frame in the foregoing method, the next two succeeding pictures are required to display the high gray-level picture and the low gray-level picture and thus the next picture is unable to display, which will cause the images to display discontinuously. Therefore, the present invention further provides a method which is able to perform plural alternative switches of the high gray-level pictures and the low gray-level pictures in one frame. Please refer to FIG. 2, which is a relative table 20 to illustrate the order of the pictures corresponding to the status of the light source, wherein the successive frames are F1, F2, F3, F4, F5, F6 . . . Fn, F(n+1), F(n+2), n is a positive integer. The picture I1 is displayed in F1. In F2, all the gate lines are turned on to simultaneously receive the voltage signals of the high gray-level picture from the signal lines, and then simultaneously receive the voltage signals of the low gray-level picture from the signal lines. Accordingly, the high gray-level pictures (high) and low gray-level pictures (low) are repeatedly and alternatively switched in the frame F2, then the next picture I2 is displayed in F3. Then, all the gate lines are turned on again to repeatedly and alternatively switch the high gray-level pictures (high) and low gray-level pictures (low) in the frame F4, . . . the final picture Im is displayed in Fn, and then all the gate lines are turned on again to repeatedly and alternatively switch the high gray-level pictures (high) and low gray-level pictures (low) in the frame F(n+1). Because the high gray-level pictures and low gray-level pictures can be displayed by scanning the whole image in one frame, all the gate lines are turned on to repeatedly and alternatively switch the high gray-level pictures (high) and low gray-level pictures (low) in one frame such as F2, F4 . . . F(n+1). Therefore, only one frame is utilized to perform the rapid switches of the high gray-level pictures and low gray-level pictures after displaying every picture to effectively prevent the image sticking for a liquid crystal display during displaying.

In the foregoing embodiment, when performing the rapid switches of the high gray-level pictures and low gray-level pictures, the light source of the LCD is turned off to avoid the flicker which makes the viewer feel uncomfortable. On the other hand, the rapid switches of the high gray-level pictures and low gray-level pictures in one frame can not only solve and avoid the image sticking, but also shorten the response time when the final display picture is a low gray-level picture, such as the black picture in one frame.

### (2) Method Applied at the Turning-Off Status of the LCD

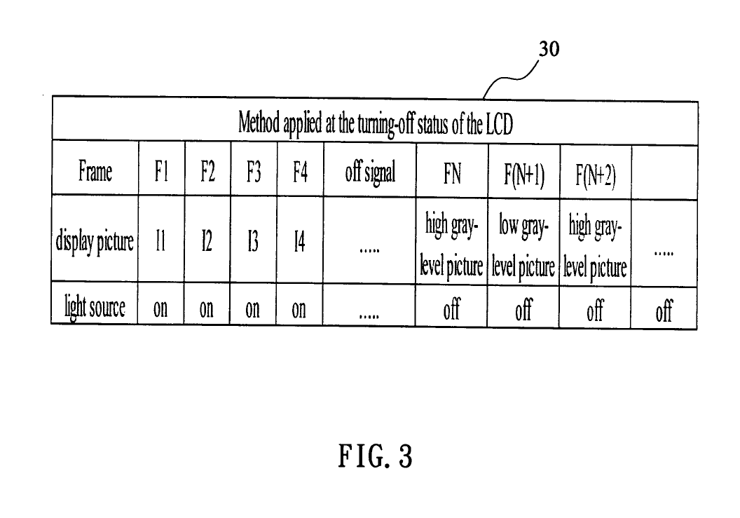

Please refer to FIG. 3, which is a relative table 30 to illustrate the order of the pictures corresponding to the status of the light source, wherein the image is constituted of a series of successive pictures (I1, I2, I3, . . . Im, m is a positive integer) and the successive frames, F1, F2, F3, F4, F5, F6 . . . Fn, F(n+1), F(n+2) correspond to the successive pictures respectively. Understandably, the picture I1 is displayed in F1, the picture I2 is displayed in F2, the picture I3 is displayed in F3, the picture I4 is displayed in F4 . . . etc. and the light source is turned on when displaying the forgoing pictures. When the off signal of the LCD is inputted, the light source is turned off and then the high gray-level picture and the low gray-level picture are switched alternatively in the following frame Fn, F(n+1), F(n+2), . . . etc. to remove the image sticking from the previous display, and all the LCD power is turned off after a period of time.

Nowadays, the display image, such as the television logo or the background of a talking program, exists the static images, hence this method isn't limited to be performed after a long-term static image. It can be performed whenever turning off the LCD by turning off the backlight source first, and then performing the switches of the high gray-level pictures and the low gray-level pictures for a period of time to improve the local or the complete image sticking effectively.

To sum up, the present invention utilizes the rapid switches between the high gray-level pictures and low gray-level pictures to adjust the ion densities of the pixels to the same or approximately the same and then present a uniform image to prevent the generation of the permanent image sticking effectively. The present invention is suitable for any LCD with different backlight module, and can be performed on any time to have the high practicability. And furthermore, the present invention also has the advantage of removing the residue image.

Although the present invention has been explained in relation to its preferred embodiment, it is to be understood that other modifications and variation can be made without departing the spirit and scope of the invention as hereafter claimed.

What is claimed is:

1. A method of preventing an image sticking for a liquid crystal display, said liquid crystal display including a display panel to display an image having a plurality of pictures, a backlight module providing a light source, a plurality of signal lines transmitting voltage signals to said display panel, and a plurality of gate lines transmitting scanning signals to said display panel, wherein said method comprises providing at least an image-amendment set containing a high gray-level picture and a low gray-level picture between any two adjacent pictures.

2. The method of preventing an image sticking for a liquid crystal display according to claim 1, wherein said high gray-level picture is a white picture and said low gray-level picture is a black picture.

3. The method of preventing an image sticking for a liquid crystal display according to claim 1, wherein said high gray-level picture is provided earlier than said low gray-level picture in said image-amendment set.

4. The method of preventing an image sticking for a liquid crystal display according to claim 1, wherein said low gray-level picture is provided earlier than said high gray-level picture in said image-amendment set.

5. The method of preventing an image sticking for a liquid crystal display according to claim 1, wherein said backlight module is turned on when displaying said pictures and said backlight module is turned off when displaying said image-amendment set.

6. The method of preventing an image sticking for a liquid crystal display according to claim 1, wherein when displaying said high gray-level picture, all said gate lines are turned on to simultaneously receive said voltage signals of said high gray-level picture from said signal lines.

7. The method of preventing an image sticking for a liquid crystal display according to claim 1, wherein when displaying said low gray-level picture, all said gate lines are turned on to simultaneously receive said voltage signals of said low gray-level picture from said signal lines.

8. A method of preventing an image sticking for a liquid crystal display, said liquid crystal display includes a display panel to display an image and a backlight module to provide a light source, wherein said method comprises alternatively switching at least a high gray-level picture and a low gray-level picture for said display panel during a turning-off process of said liquid crystal display.

9. The method of preventing an image sticking for a liquid crystal display according to claim 8, wherein said high gray-level picture is a white picture and said low gray-level picture is a black picture.

10. The method of preventing an image sticking for a liquid crystal display according to claim 8, wherein said backlight module is turned off when alternatively switching said high gray-level picture and said low gray-level picture.
